(19) United States
(12) Patent Application Publication
(10) Pub. No.: US 2005/0150336 A1
(43) Pub. Date: Jul. 14, 2005

(54) Snap-ring groove cutting tool for portable line boring machine

(75) Inventor: Dennis Donald Cambrey, Black Creek (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Dennitech Industries Ltd., Campbell River (CA)

(21) Appl. No.: 10/753,313

(22) Filed: Jan. 9, 2004

(51) Int. Cl. B23B 41/00

(52) U.S. Cl. 82/1.2

(57) ABSTRACT

A piston mounted in a tool body is perpendicularly movable relative to the tool's longitudinal axis. A tool bit mounted on the piston protrudes perpendicularly away from the tool's body, relative to the longitudinal axis. A coupler rotatably and drivingly couples the tool to a line boring machine. The machine is operated to rotate and longitudinally move the tool along the longitudinal axis into a work piece bore, to position the rotating tool bit's cutting tip adjacent a selected internal circumferential portion of the work piece. Pressurized hydraulic fluid is then controllably applied to the piston, through the tool, to perpendicularly outwardly advance the piston relative to the longitudinal axis, forcing the rotating cutting tip into the work piece to cut a snap-ring groove. A spring mounted between the body and the piston biases the piston toward the longitudinal axis, retracting the tool bit when the fluid pressure is relieved.

### TECHNICAL FIELD

This invention is directed to cutting internal snap-ring grooves in work environments other than fully-equipped machine shops.

### BACKGROUND

Cylindrical bores machined in metal work pieces are sometimes internally grooved to accommodate snap-rings. It is difficult to cut snap-ring grooves, or re-cut damaged snap-ring grooves outside a properly equipped machine shop. For example, the work piece may be part of a marine propulsion system, or part off an off-road excavating machine, etc. Properly equipped machine shops are capable of cutting snap-ring grooves in such work pieces, but the machine shop equipment is typically a large, expensive structure which is difficult to transport and cumbersome to operate outside a properly equipped machine shop. These problems could be avoided if it were possible to bring the work piece into a properly equipped workshop. But, the work piece is often part of a relatively massive piece of equipment which can be as difficult to transport as the machine shop equipment. Moreover, it is normally necessary to complete the snap-ring groove-cutting operation quickly in order to minimize equipment down time. Accordingly, it is often necessary cut snap-ring grooves under less than ideal conditions.

This invention facilitates snap-ring groove cutting in work environments away from properly equipped machine shops, with the aid of a portable boring machine like that disclosed in U.S. Pat. No. 4,932,814.

### SUMMARY OF INVENTION

The invention provides a snap-ring groove-cutting tool. A piston is mounted in the tool's body to allow the piston to move perpendicularly relative to the tool's longitudinal axis. A tool bit mounted on the piston protrudes perpendicularly away from the tool body, relative to the longitudinal axis. A coupler rotatably and drivingly couples the tool to a line boring machine. The line boring machine is operated to rotate the tool and to longitudinally move the tool along its longitudinal axis into a work piece bore, to position the rotating tool bit's cutting tip adjacent a selected internal circumferential portion of the work piece. Pressurized hydraulic fluid is then controllably applied to the piston, through the tool, to perpendicularly outwardly advance the piston relative to the longitudinal axis, forcing the rotating cutting tip into the work piece to cut the snap-ring groove.

### BRIEF DESCRIPTION OF DRAWINGS

FIG. 1 is a sectional front elevation view of a snap-ring groove cutting tool in accordance with the invention.

FIG. 2 is an enlarged, not-to-scale, sectional view taken with respect to line 2-2 of FIG. 1.

FIG. 3 is a left end view of the FIG. 1 tool, and includes line 1-1 with respect to which the FIG. 1 sectional view is taken.

FIG. 4 is an oblique pictorial illustration of the FIG. 1 groove cutter.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

Snap-ring groove cutting tool 10's body 12 is machined to form internal, longitudinal hydraulic fluid conduits 14, 16 and internal, transverse hydraulic fluid conduit 18 which intersects conduits 14, 16. Piston chamber 20 is machined transversely in and near one end of body 12, such that chamber 20's base 22 intersects conduit 16. Piston 24 is slidably mounted in chamber 20. Gland 26 is threadably fastened to body 12, circumferentially surrounding and slidably sealing the upper end of chamber 20 around piston 24. Set screw 27 is fastened against gland 26 to prevent loosening of gland 26 after it is fastened to body 12. The lower circumferential rim 28 (FIG. 2) of gland 26 provides a bearing surface for the upper end of spring 30. The lower end of spring 30 bears against rim 32 machined in piston 24. Circumferential packing 34 inhibits hydraulic fluid passage from piston chamber 22 around piston 24 toward spring 30, when groove cutting tool 10 is operated as explained below. Socket 36 is machined in piston rod 38 to slidably and removably receive the shank of tool bit 40, which is held in place by set screw 41. Pipe plugs 42, 43 close the ends of conduits 16, 18 respectively at the end of body 12 opposite piston 24.

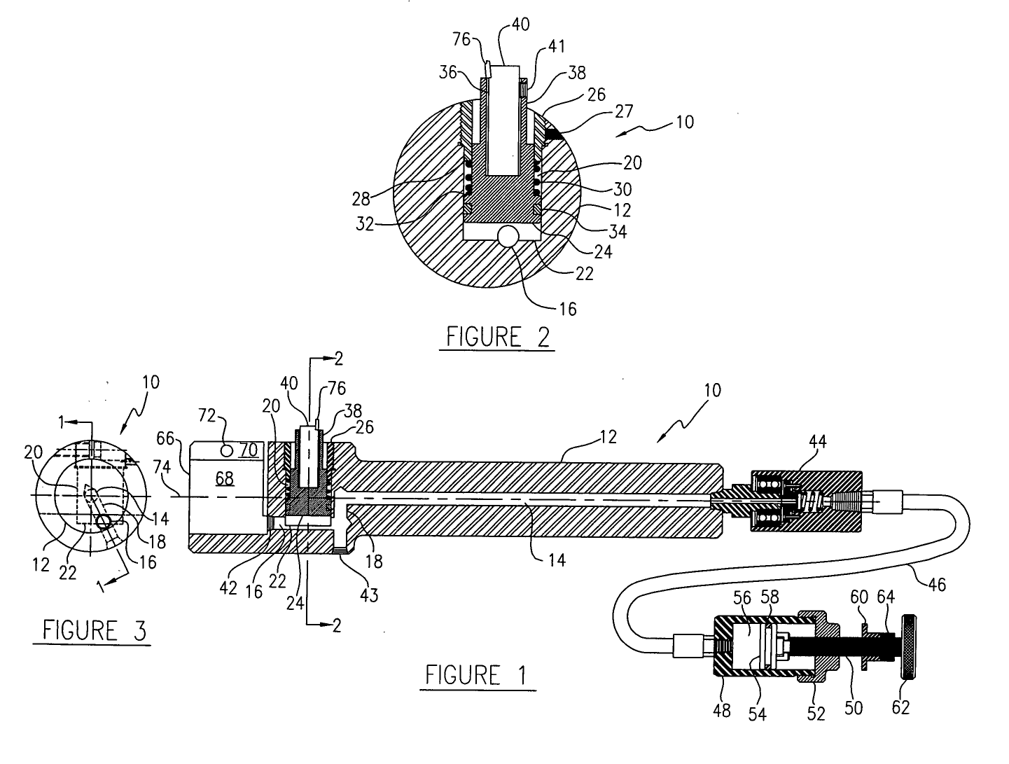

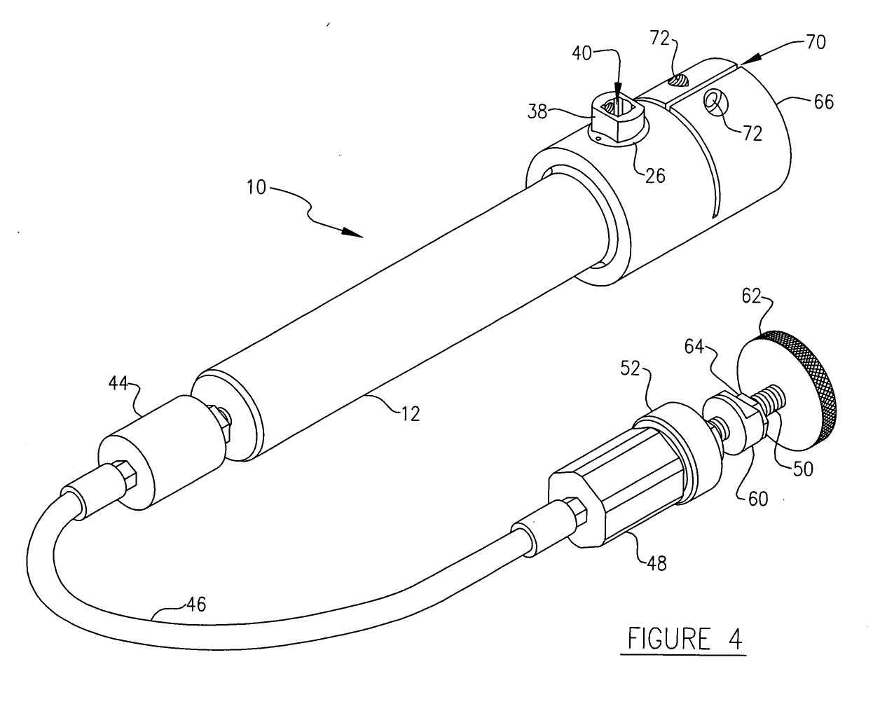

Rotary union 44 rotationally and fluidicly couples one end of external, flexible hydraulic fluid conduit 46 to a fluid inlet port end of conduit 14 at the end of body 12 opposite piston 24. Rotary union 44 may for example be a part no. 1102-070-081 rotating union available from Deublin Company, Waukegan, Ill. modified as shown in FIG. 1 by extending the union's housing and relocating the union's hydraulic fluid inlet to the end of (rather than transverse to) the housing. The opposite end of flexible conduit 46 is fluidicly coupled to the base of plunger barrel 48. Plunger rod 50 is threadably coupled through plunger gland 52 to plunger piston 54, enclosing plunger chamber 56 (which is machined to the same diameter as piston chamber 20) between the base of plunger piston 54 and the base of plunger barrel 48. Plunger packing 58 inhibits hydraulic fluid passage from plunger chamber 56 around plunger piston 54 and toward plunger rod 50, when groove cutting tool 10 is operated as explained below. Stop 60 is threadably mounted on plunger rod 50 between plunger gland 52 and plunger knob 62. Locknut 64 is threadably mounted on plunger rod 50 between stop 60 and plunger knob 62.

Clamping collar 66 is formed on the end of body 12 nearest piston 24. Collar 66 defines and encloses an open cylindrical aperture 68 which is sized to accommodate insertion, within aperture 68, of the end of a boring bar of a portable line boring machine (not shown, but like that disclosed in U.S. Pat. No. 4,932,814 which is incorporated herein by reference). Slot 70 splits collar 66 radially and axially. A nut and bolt (not shown) can be tightened through apertures 72 on opposed sides of slot 70 to compress collar 66 around the end of the boring bar, thereby removably and rotatably fastening groove cutting tool 10 to the boring bar.

In operation, plunger knob 62 is rotated (or counter-rotated) to threadably advance (or retract) plunger piston 54 within plunger chamber 56. Advancement of plunger piston 54 toward the internal base of plunger barrel 48 forces pressurized hydraulic fluid from plunger chamber 56 through flexible conduit 46, rotary union 44, longitudinal conduit 14, transverse conduit 18 and longitudinal conduit 16 into piston chamber 20. The pressurized hydraulic fluid in chamber 20 thus exerts an upward (as viewed in the drawings) force on the base of piston 24, thereby radially (i.e. perpendicularly, relative to groove cutting tool 10's longitudinal axis 74) outwardly advancing piston 24 and tool bit 40 while compressing spring 30 between rims 28, 32. Retraction of plunger piston 58 away from the internal base of plunger barrel 48 relieves the hydraulic fluid pressure applied to the base of piston 24, allowing spring 30 to expand and apply a downward (as viewed in the drawings) force to piston 24, thereby radially inwardly retracting piston 24 and tool bit 40. Because plunger chamber 56 has the same diameter as piston chamber 20, advancement (or retraction) of plunger chamber 56 through a selected displacement advances (or retracts) piston 24 and tool bit 40 through the same displacement.

When groove cutting tool 10 is fastened to the boring bar of a line boring machine as aforesaid, plunger knob 62 is initially counter-rotated to radially inwardly retract tool bit 40 sufficiently to allow tool 10 and tool bit 40 to be fed linearly into a work piece bore (not shown). Locknut 64 and stop 60 are initially threadably retracted along plunger rod 50 away from plunger gland 52 toward plunger knob 62. The line boring machine is then coupled to the work piece and operated in conventional fashion to drivingly rotate the boring bar. Such rotation simultaneously rotates tool 10, including tool bit 40, about tool 10's longitudinal axis 74. Further conventional operation of the line boring machine linearly advances the boring bar and rotating tool bit 40 into the work piece aperture to position tool bit 40's cutting tip 76 adjacent a selected internal circumferential portion of the work piece bore at which a snap-ring groove (not shown) is to be cut, or at which a damaged snap-ring groove is to be re-cut. Plunger knob 62 is then rotated to advance tool bit 40 radially outwardly until tool bit 40's cutting tip 76 just touches the work piece. Stop 60 is then threadably advanced along plunger rod 50 until the displacement between plunger gland 52 and stop 60 equals the desired depth of the snap-ring groove. Locknut 64 is then tightened against stop 60 to prevent variation of the desired displacement between plunger gland 52 and stop 60. Plunger knob 62 is then rotated to further advance tool bit 40's cutting tip 76 radially outwardly into the work piece to cut the snap-ring groove. Rotation of plunger knob 62 is continued until stop 60 contacts plunger gland 52—indicating that the snap-ring groove has been cut to the desired depth. Plunger knob 62 is then counter-rotated to radially inwardly retract tool bit 40 away from the snap-ring groove. The line boring machine is then operated to linearly withdraw groove cutting tool 10 and tool bit 40 from the work piece.

As will be apparent to those skilled in the art in the light of the foregoing disclosure, many alterations and modifications are possible in the practice of this invention without departing from the spirit or scope thereof. For example, spring 30 is not essential and can be omitted: if piston packing 34 and plunger packing 58 adequately seal pistons 24, 54 within their respective chambers 20, 56 counter-rotation of plunger 62 produces a suction force sufficient to radially inwardly retract tool bit 40. Accordingly, the scope of the invention is to be construed in accordance with the substance defined by the following claims.

1. A snap-ring groove cutting tool, comprising:
(a) a body;
(b) a piston mounted in the body for perpendicular movement of the piston relative to a longitudinal axis of the tool;
(c) a tool bit mounted on the piston to protrude perpendicularly away from the body relative to the longitudinal axis;
(d) a coupler for rotatably drivingly coupling the tool to apparatus for rotating and longitudinally moving the tool relative to the longitudinal axis; and,
(e) hydraulic fluid supply means for controllably applying pressurized hydraulic fluid to the piston to perpendicularly outwardly advance the piston and the tool bit relative to the longitudinal axis.

2. A snap-ring groove cutting tool as defined in claim 1, further comprising retraction means for inwardly retracting the piston and the tool bit relative to the longitudinal axis.

3. A snap-ring groove cutting tool as defined in claim 2, further comprising a piston chamber in the body for slidable mounting of the piston in the piston chamber, and wherein the retraction means further comprises a spring mounted between the body and the piston to bias the piston perpendicularly inwardly relative to the longitudinal axis.

4. A snap-ring groove cutting tool as defined in claim 3, wherein the hydraulic fluid supply means further comprises:
(a) an internal hydraulic fluid conduit extending through the body between the piston chamber and a fluid inlet port;
(b) an external hydraulic fluid conduit;
(c) a rotary union fluidicly coupling one end of the external hydraulic fluid conduit to the fluid inlet port; and,
(d) a hydraulic fluid plunger fluidicly coupled to an opposite end of the external hydraulic fluid conduit.

5. A snap-ring groove cutting tool as defined in claim 4, wherein the hydraulic fluid plunger further comprises a plunger chamber having the same diameter as the piston chamber.

6. A snap-ring groove cutting tool as defined in claim 5, wherein the hydraulic fluid plunger further comprises:
(a) a plunger piston slidably mounted in the plunger chamber;
(b) a plunger rod coupled to the plunger piston and extending from the plunger chamber; and,
(c) a stop mounted on and adjustably positionable along the plunger rod between a first position at a selected displacement away from the plunger chamber and a second position contacting the plunger chamber.

7. A snap-ring groove cutting tool as defined in claim 4, wherein the coupler further comprises:
(a) a collar on one end the tool, the collar having an aperture for receiving a rotatable drive member; and,
(b) a fastener for fastening the collar to the drive member.

8. A snap-ring groove cutting tool as defined in claim 7, wherein the fluid inlet port is at an end of the tool opposite the one end the tool.

9. A snap-ring groove cutting tool as defined in claim 8, wherein the piston and the tool bit are near the one end the tool.

10. A method of cutting an internal snap-ring groove, comprising:
(a) mounting a piston in a body for perpendicular movement of the piston relative to a longitudinal axis;
(b) mounting a tool bit on the piston to protrude perpendicularly relative to the longitudinal axis;
(c) coupling the body to a line boring machine;
(d) operating the line boring machine to drivingly rotate the body relative to the longitudinal axis;
(e) further operating the line boring machine to longitudinally move the body, piston and tool bit relative to the longitudinal axis and into a work piece bore; and,
(f) controllably applying pressurized hydraulic fluid to the piston to perpendicularly outwardly advance the piston and the tool bit relative to the longitudinal axis.
